(19) United States
(12) Patent Application Publication
(10) Pub. No.: US 2017/0294933 A1
(43) Pub. Date: Oct. 12, 2017

(54) Electronic Device Mounting Assembly

(71) Applicant: Michael Graham, Antioch, CA (US)

(72) Inventor: Michael Graham, Antioch, CA (US)

(21) Appl. No.: 15/095,871

(22) Filed: Apr. 11, 2016

(51) Int. Cl. H04B 1/3877; H04M 1/06; H04M 1/02

(52) U.S. Cl. CPC H04B 1/3877; H04M 1/026; H04M 1/06

(57) ABSTRACT

An electronic device mounting assembly includes a case that may contain an electronic device. A receiver is coupled to the case. A first electrical circuit is coupled to the case. The first electrical circuit may be in electrical communication with the electronic device. A set of couplers is provided. Each of the couplers may be selectively coupled to a vehicle. A selected one of the couplers engages the receiver to removably coupled the selected coupler to the case. Thus, the selected coupler couples the electronic device to the vehicle. Each of the couplers has a second electrical circuit coupled thereto. The second electrical circuit is in electrical communication with the first electrical circuit when the selected coupler is coupled to the receiver. The second electrical circuit may be placed in electrical communication with an extrinsic electronic device thereby facilitating the electronic device to communicate with the extrinsic electronic device.

### BACKGROUND OF THE DISCLOSURE

### Field of the Disclosure

The disclosure relates to mounting devices and more particularly pertains to a new mounting device for movably coupling an electronic device to a vehicle.

### SUMMARY OF THE DISCLOSURE

An embodiment of the disclosure meets the needs presented above by generally comprising a case that may contain an electronic device. A receiver is coupled to the case. A first electrical circuit is coupled to the case. The first electrical circuit may be in electrical communication with the electronic device. A set of couplers is provided. Each of the couplers may be selectively coupled to a vehicle. A selected one of the couplers engages the receiver such that the selected coupler is removably coupled to the case. Thus, the selected coupler couples the electronic device to the vehicle. Each of the couplers has a second electrical circuit coupled thereto. The second electrical circuit is in electrical communication with the first electrical circuit when the selected coupler is coupled to the receiver. The second electrical circuit may be placed in electrical communication with an extrinsic electronic device thereby facilitating the electronic device to communicate with the extrinsic electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of an electronic device mounting assembly according to an embodiment of the disclosure.

FIG. 2 is a perspective view of a coupler of an embodiment of the disclosure.

FIG. 3 is a back perspective view of an embodiment of the disclosure.

FIG. 4 is a back phantom view of an embodiment of the disclosure.

FIG. 5 is a left side cutaway view of an embodiment of the disclosure.

FIG. 6 is a back phantom view of a third coupler of an embodiment of the disclosure.

FIG. 7 is a left side cutaway view of an alternative embodiment of an embodiment of the disclosure.

FIG. 8 is a perspective view of a second coupler of an embodiment of the disclosure.

### DESCRIPTION OF THE PREFERRED EMBODIMENT

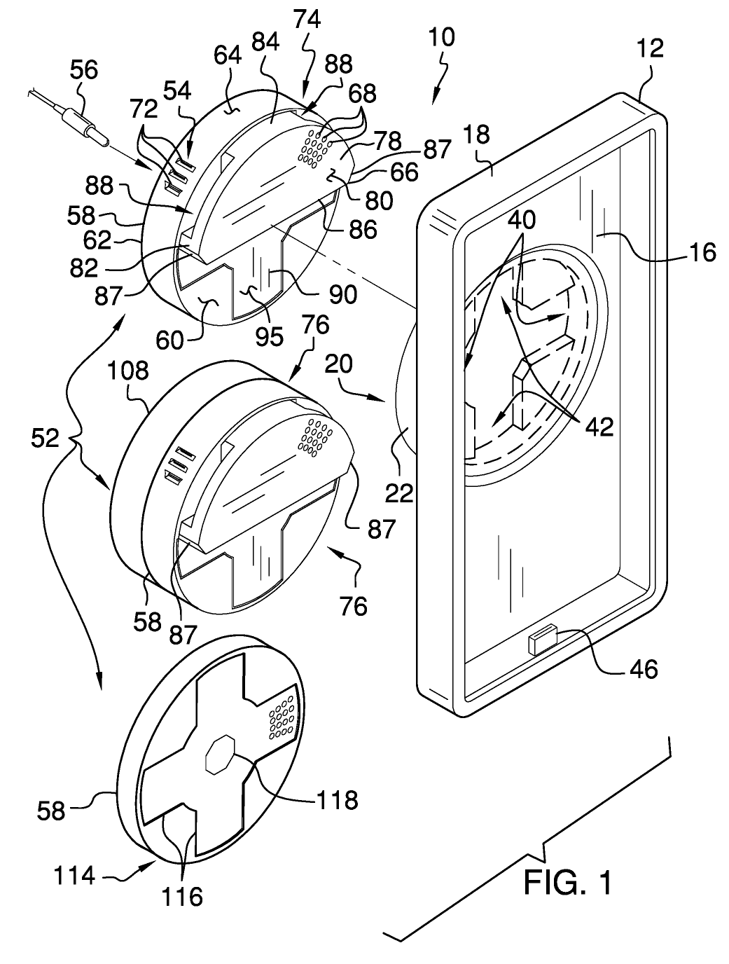

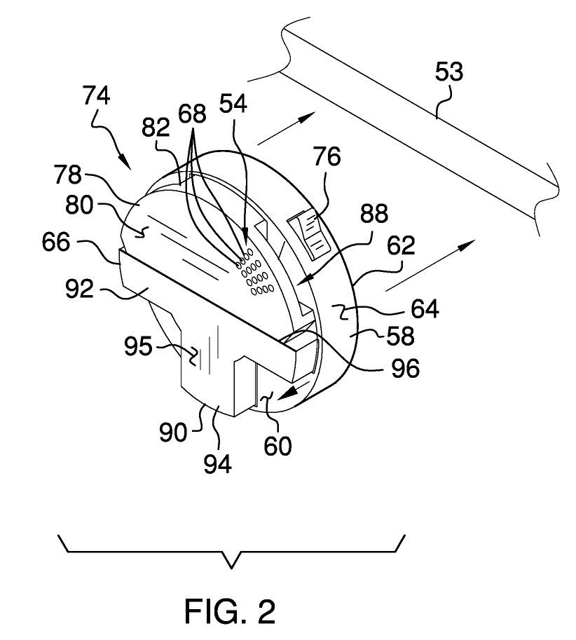

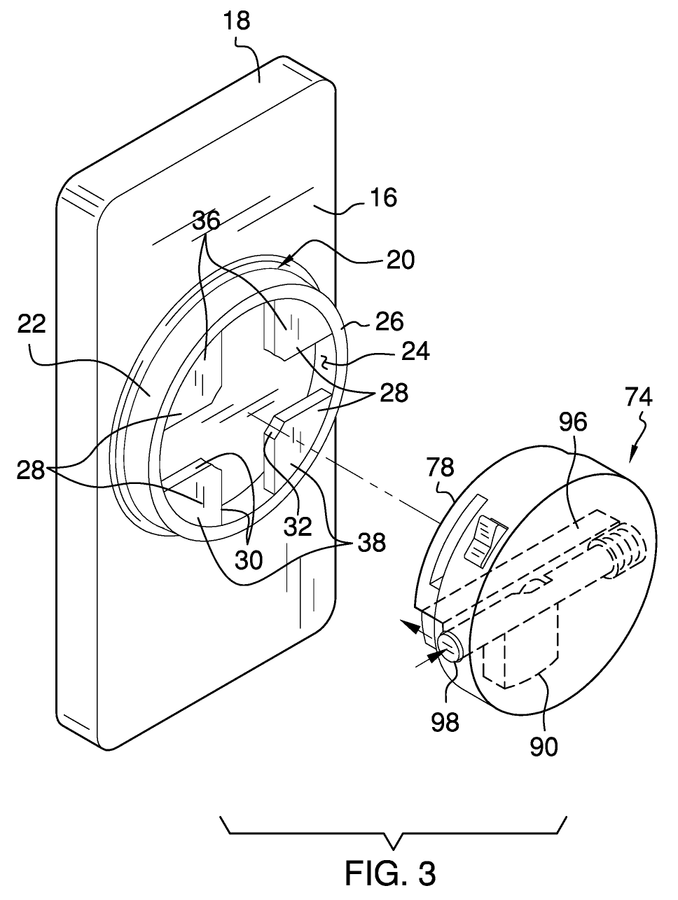

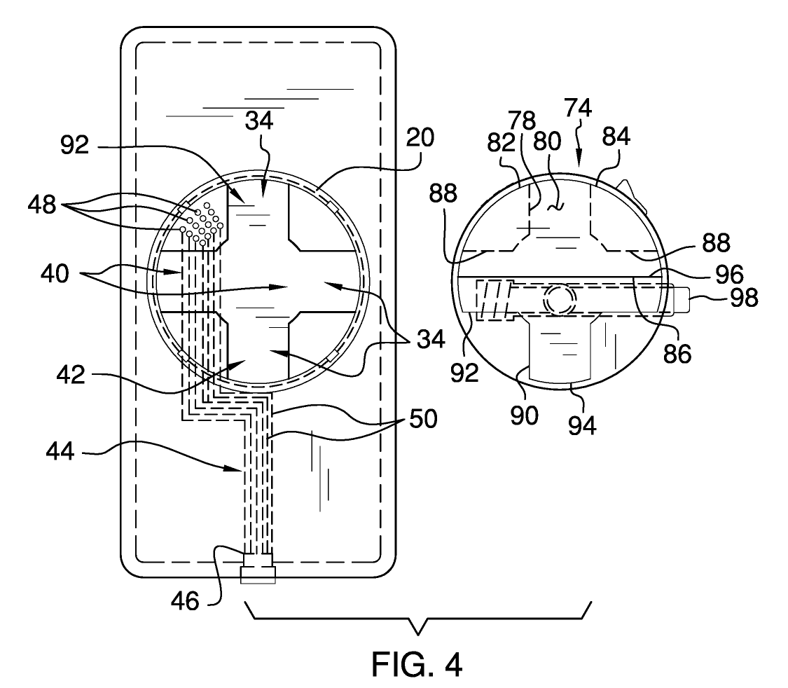

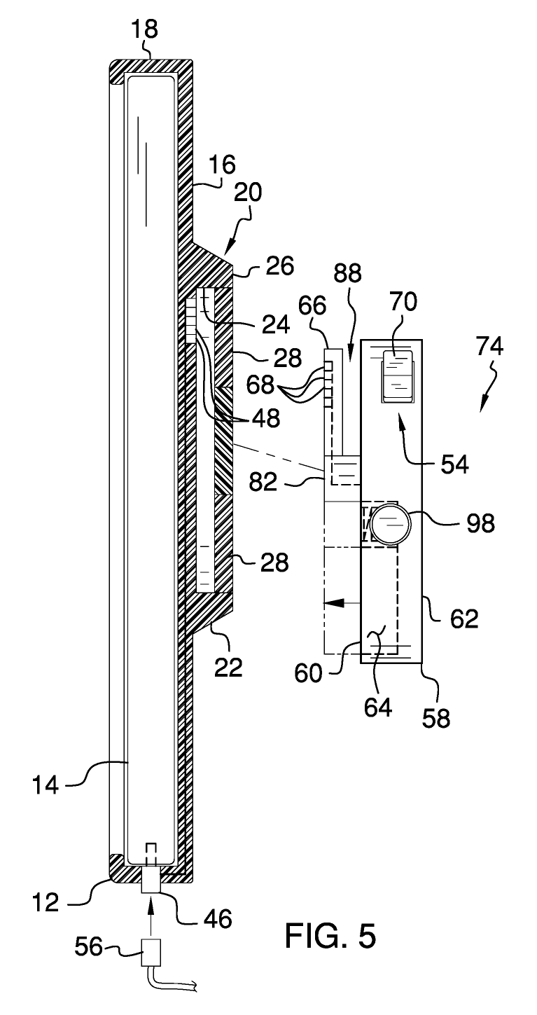

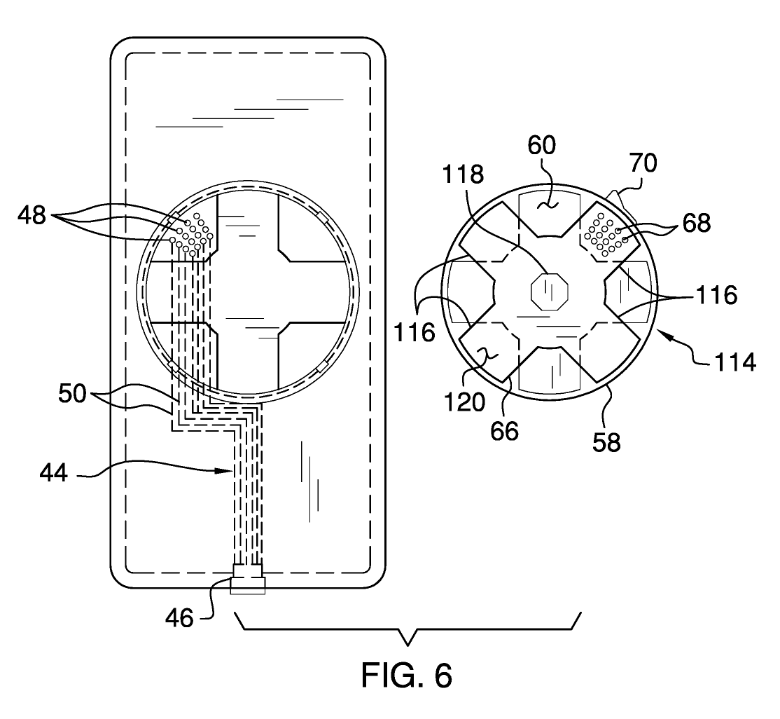

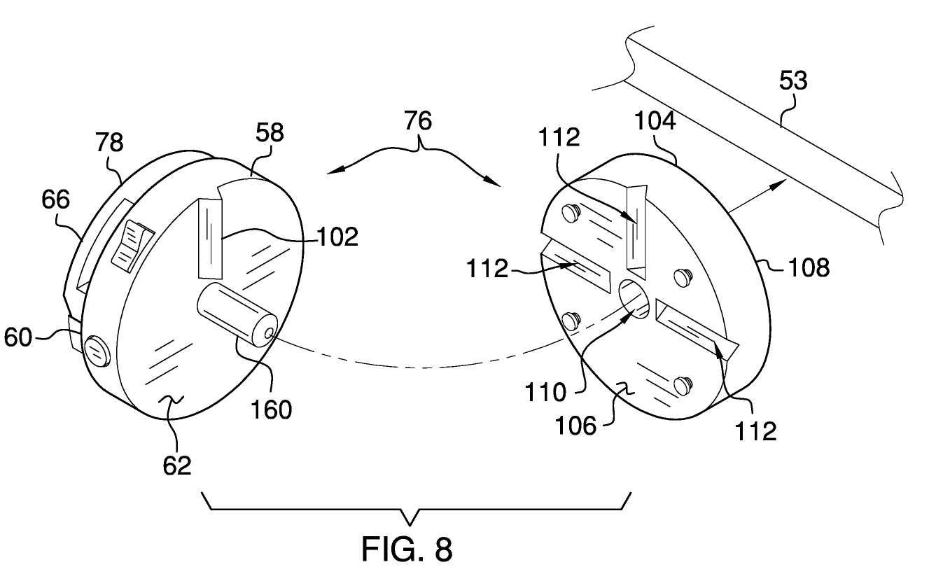

With reference now to the drawings, and in particular to FIGS. 1 through 8 thereof, a new mounting device embodying the principles and concepts of an embodiment of the disclosure and generally designated by the reference numeral 10 will be described.

As best illustrated in FIGS. 1 through 8, the electronic device mounting assembly 10 generally comprises a case 12 that may contain an electronic device 14. The case 12 has a back wall 16 and a peripheral wall 18. The electronic device 14 may comprise a smart phone or the like. The case 12 may comprise a smart phone case or the like.

A receiver 20 is coupled to the case 12. The receiver 20 has an outer wall 22 that is coupled to and extends away from the back wall 16 of the case 12. The outer wall 22 is continuous such that the outer wall 22 defines a circle. The outer wall 22 has an inner surface 24 and a distal edge 26 with respect to the back wall 16.

A plurality of tabs 28 is provided and each of the tabs 28 is coupled to the inner surface 24. Each of the tabs 28 has a pair of lateral edges 30 and a distal edge 32 with respect to the outer wall 22. Each of the lateral edges 30 corresponding to each of the tabs 28 angles inwardly between the outer wall 22 and the distal edge 32 of the corresponding tab 28. Thus, each of the tabs 28 has a trapezoidal shape.

The tabs 28 are spaced apart from each other and are distributed around the outer wall 22 to define a plurality of slots 34 between each of the tabs 28. Each of the tabs 28 is aligned with the distal edge 32 corresponding to the outer wall 22. Moreover, each of the tabs 28 is spaced from the back wall 16 of the case 12. The plurality of tabs 28 includes an upper set of tabs 36 and a lower set of tabs 38. The plurality of slots 34 includes a pair of horizontally oriented slots 40 and a pair of vertically oriented slots 42.

A first electrical circuit 44 is coupled to the case 12. The first electrical circuit 44 may be in electrical communication with the electronic device 14 when the electronic device 14 is positioned in the case 12. The first electrical circuit 44 comprises a first contact 46 that is coupled to the peripheral wall 18 of the case 12. Thus, the first contact 46 may be placed in electrical communication with the electronic device 14 when the electronic device 14 is positioned in the case 12.

A plurality of second contacts 48 is provided. Each of the second contacts 48 is coupled to the back wall 16 of the case 12. Each of the second contacts 48 is positionally aligned with an associated one of the tabs 38 in the receiver 20. A plurality of first conductors 50 is provided and each of the first conductors 50 is positioned within the back wall 16 of the case 23. Each of the first conductors 50 is electrically coupled between an associated one of the second contacts 48 and the first contact 46. Thus, each of the second contacts 48 may be in electrical communication with the electronic device 14 when the electronic device 14 is positioned in the case 12.

A set of couplers 52 is provided. Each of the couplers 52 may be selectively coupled to a vehicle 53. The vehicle 53 may be a bicycle or the like and the couplers 52 may be positioned on a handlebar of the bicycle. Each of the couplers 52 may be coupled to the vehicle 53 through any conventional means such as a clamp or the like.

A selected one of the couplers 52 engages the receiver 20 such that the selected coupler 52 is removably coupled to the case 12. Thus, the selected coupler 52 may couple the electronic device 14 to the vehicle 53. Each of the couplers 52 includes a second electrical circuit 54. The second electrical circuit 54 is in electrical communication with the first electrical circuit 44 when the selected coupler 52 is coupled to the receiver 20. Thus, the selected coupler 52 is in electrical communication with the electronic device 14 when the electronic device 14 is positioned in the case 12.

The second electrical circuit 54 may be placed in electrical communication with an extrinsic electronic device 56. Thus, the electronic device 14 may communicate with the extrinsic electronic device 56. The extrinsic electronic device 56 may comprise a charger, an electronic storage unit or personal computer. Additionally, the extrinsic electronic device 56 may control operational parameters of the electronic device 14.

Each of the set of couplers 52 includes a disk 58 that has a first surface 60, a second surface 62 and an outer surface 64 extending therebetween. The second surface 62 may be coupled to the vehicle 53. A lock 66 is coupled to the first surface 60. The lock 66 engages the tabs 28 when the selected coupler 52 is positioned in the receiver 20. Thus, the selected coupler 52 is removably coupled to the case 12.

The second electrical circuit 54 comprises a plurality of third contacts 68. Each of the third contacts 68 is coupled to the lock 66. Each of the third contacts 68 is electrically coupled to an associated one of the second contacts 48 when the selected coupler 52 is positioned in the receiver 20. A switch 70 is coupled to the outer surface 64 of the disk 58 and the switch 70 may be manipulated. The switch 70 is electrically coupled to each of the third contacts 68. The switch 70 may control operational parameters of the electronic device 14 when the electronic device 14 is positioned in the case 12.

A plurality of ports 72 is provided and each of the ports 72 is coupled to the outer surface 64 of the disk 58. Thus, each of the ports 72 may be electrically coupled to the extrinsic electronic device 56. Each of the ports 72 is electrically coupled to the third contacts 68. Thus, each of the ports 72 may be in electrical communication with the electronic device 14. The plurality of ports 72 may include a micro usb port, a mini usb port and a lightning usb port.

The set of couplers 52 includes a first coupler 74 and a second coupler 76. A selected one of the first coupler 74 and the second coupler 76 is removably coupled to the receiver 20. The lock 66 corresponding to each of the first coupler 74 and the second coupler 76 comprises a wafer 78 that is coupled to the first surface 60 of the disk 58. The wafer 78 has a distal surface 80 with respect to the first surface 60 and an outermost edge 82.

The outermost edge 82 has a first side 84 and a second side 86, and the first side 84 is substantially coextensive with the outer surface 64 of the disk 58. The second side 86 extends laterally across the first surface 60 such that the wafer 78 has a semicircular shape. Each of a pair of intersections 87 between the first side 84 and the second side 86 are chamfered. The first side 84 is inset with respect to the outer surface 64. The first side 84 has a pair of wells 88 extending inwardly toward a center of the wafer 78 and the wells 88 are spaced apart from each other.

The wafer 78 extends into the pair of horizontally oriented slots 40 when the first coupler 74 and the second coupler 76 are inserted into the receiver 20. The chamfered intersections 87 facilitate the wafer 78 to avoid frictionally engaging the lower set of tabs 38. Each of the first coupler 74 and the second coupler 76 are urged upwardly in the receiver 20. Thus, each of the upper set of tabs 36 is positioned in an associated one of the wells 88 such that the first coupler 74 and the second coupler 76 are removably coupled to the receiver 20.

The second side 86 of the wafer 78 is centrally positioned in the pair of horizontally oriented slots 40 when the first coupler 74 and the second coupler 76 are removably coupled to the receiver 20. Each of the third contacts 68 corresponding to the first coupler 74 and the second coupler 76 are positioned on the distal surface 80 of the wafer 78. Thus, each of the third contacts 68 corresponding to the first coupler 74 and the second coupler 76 is electrically coupled to the second contacts 48 when the first coupler 74 and the second coupler 76 are coupled to the receiver 20.

A retainer 90 is movably coupled to the first surface 60 of the disk 58. The retainer 90 comprises a first arm 92 intersecting with a second arm 94. The second arm 94 is centrally positioned on the first arm 92 such that the retainer 90 has a T-shape. The retainer 90 has an exposed surface 95 and the first arm 92 has an upper edge 96. The upper edge 96 is coextensive with the second side 86 of the wafer 78.

The retainer 90 is positioned in a retracted position having the retainer 90 being recessed in the first surface 60 of the disk 58. The retainer 90 is positioned in an extended position having the retainer 90 extending outwardly from the first surface 60. Thus, the exposed surface 95 of the retainer 90 is oriented on a plane that is planar with the distal surface 80 of the wafer 78. The first arm 92 is coextensive with the horizontally oriented slots 40 when the retainer 90 is in the extended position. The second arm 94 extends downwardly in an associated one of the vertically oriented slots 42. Thus, the retainer 90 inhibits the first coupler 74 and the second coupler 76 from sliding downwardly in the receiver 20.

Each of the first coupler 74 and the second coupler 76 includes an actuator 98, and the actuator 98 may be manipulated. The actuator 98 is in mechanical communication with the retainer 90 through any conventional means. The actuator 98 urges the retainer 90 into the extended position when the first coupler 74 and the second coupler 76 are positioned in the receiver 20. Thus, the first coupler 74 and the second coupler 76 are locked in the receiver 20. The actuator 98 urges the retainer 90 into the retracted position when the first coupler 74 and the second coupler 76 are positioned in the receiver 20. Thus, the first coupler 74 and the second coupler 76 are removable from the receiver 20.

The second coupler 76 includes a shaft 100 that is coupled to and extends away from the second surface 62 of the disk 58. The shaft 100 is centrally positioned on the second surface 62. A ridge 102 extends outwardly from the second surface 62. The ridge extends 102 substantially between the outer surface 64 of the second coupler 76 and the shaft 100.

The second coupler 76 further includes a second disk 104 that has a primary surface 106 and a secondary surface 108. The secondary surface 108 may be coupled to the vehicle 53. The primary surface 106 has a first well 110 extending inwardly toward the secondary surface 108. The first well 110 is centrally positioned on the primary surface 106. The secondary surface 108 has a plurality of channels 112 extending inwardly toward the secondary surface 108. Each of the channels 112 is positioned to radiate outwardly from the first well 110.

The first well 110 insertably receives the shaft 100. The shaft 100 frictionally engages the first well 110 such that the second coupler 76 is movably coupled to the second disk 104. The second coupler 76 is rotated to align the ridge 102 with a selected one of the channels 112. The ridge 102 engages the selected channel 112 and the second coupler 76 is retained at a selected angle of rotation about the shaft 100. Thus, the second disk 104 may position the electronic device 14 in a landscape position and a portrait position.

The set of couplers 52 includes a third coupler 114 and the third coupler 114 is selectively coupled to the receiver 20. The lock 66 corresponding to the third coupler 114 comprises a plurality of arms 116 each radiating outwardly from a central hub 118. The central hub 118 is coupled to the first surface 60 corresponding to the third coupler 114. Each of the arms 116 is spaced from the first surface 60 and each of the arms 116 has an engaging surface 120.

Each of the arms 116 extends into an associated one of the slots 34 in the receiver 20. The third coupler 114 is urged to rotate into a locked position having each of the arms 116 positioned behind an associated one of the tabs 28. Thus, the third coupler 114 is removably coupled to the receiver 20. The third coupler 114 is urged to rotate in an unlocked position having each of the arms 116 being aligned with the associated slot 34. Thus, the third coupler 114 is removable from the receiver 20. Each of the third contacts 68 corresponding to the third coupler 114 is coupled to the engaging surface 120 of an associated one of the arms 116. Thus, the third contacts 68 are electrically coupled to the second contacts 48 when the third coupler 114 is coupled to the receiver 20.

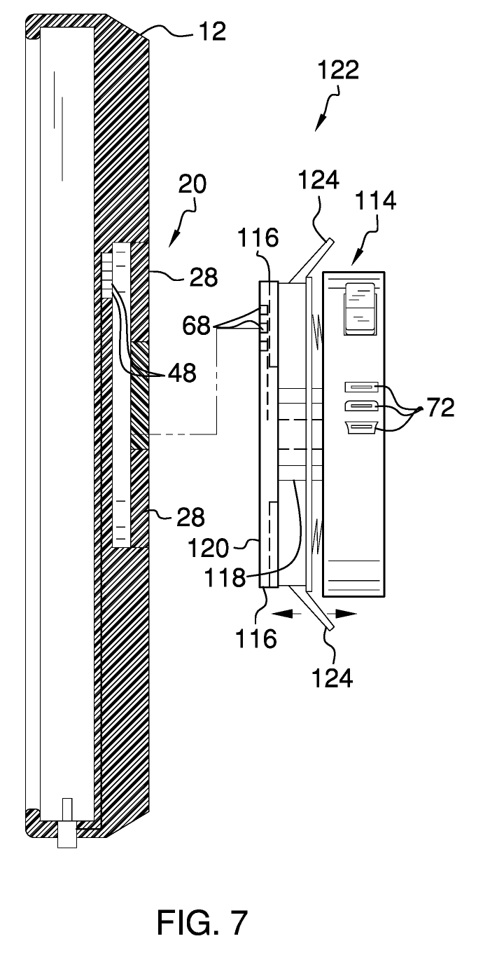

In an alternative embodiment 122 as shown in FIG. 7, the receiver 20 may be recessed into the back wall 16 of the case 12. The third coupler 114 may include a pair of tabs 124 and each of the tabs 124 may be movably coupled to the lock 66 corresponding to the third coupler 114. The lock 66 corresponding to the third coupler 114 may be rotatably coupled to the third coupler 114. Each of the tabs 124 may be manipulated to rotate the lock 66 corresponding to the third coupler 114 into the locked position and the unlocked position.

In use, a selected one of the first coupler 74 and the third coupler 114 are removably coupled to the receiver 20. The selected first coupler 74 and third coupler 114 are coupled to the vehicle 53. Thus, the electronic device 14 is positioned to be manipulated while the vehicle 53 is driven. The second coupler 76 is selected when the electronic device 14 is to be positioned in the landscape position. The extrinsic electronic device 56 is electrically coupled to a selected one of the ports 72. Thus, the electronic device 14 is in electrical communication with the extrinsic electronic device 56 when the electronic device 17 is positioned in the case 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electronic device mounting assembly being configured to mount an electronic device to a vehicle, said assembly comprising:
a case being configured to contain an electronic device, said case having a back wall and a peripheral wall;
a receiver being coupled to said case;
a first electrical circuit being coupled to said case, said first electrical circuit being configured to be in electrical communication with the electronic device when the electronic device is positioned in said case; and
a set of couplers, each of said couplers being configured to be selectively coupled to a vehicle, a selected one of said couplers engaging said receiver such that said selected coupler is removably coupled to said case wherein said selected coupler is configured to couple the electronic device to the vehicle, each of said couplers having a second electrical circuit being coupled thereto, said second electrical circuit being in electrical communication with said first electrical circuit when said selected coupler is coupled to said receiver wherein said selected coupler is configured to be in electrical communication with the electronic device when the electronic device is positioned in said case, said second electrical circuit being configured to be placed in electrical communication with an extrinsic electronic device thereby facilitating the electronic device to communicate with the extrinsic electronic device.

2. The assembly according to claim 1, wherein said receiver has an outer wall being coupled to and extending away from said back wall of said case, said outer wall being continuous such that said outer wall defines a circle, said outer wall having an inner surface and a distal edge with respect to said back wall, said receiver having a plurality of tabs, each of said tabs being coupled to said inner surface.

3. The assembly according to claim 2, wherein each of said tabs has a pair of lateral edges and a distal edge with respect to said outer wall, each of said lateral edges corresponding to each of said tabs angling inwardly between said outer wall and said distal edge of said corresponding tab such that each of said tabs has a trapezoidal shape, said tabs being spaced apart from each other and being distributed around said outer wall to define a plurality of slots between said lateral edges corresponding to each of said tabs, each of said tabs being aligned with said distal edge corresponding to said outer wall such that each of said tabs is spaced from said back wall of said case, said plurality of tabs including an upper set of tabs and a lower set of tabs, said slots including a pair of horizontally oriented slots and a pair of vertically oriented slots.

4. The assembly according to claim 2, wherein said first electrical circuit comprises:
a first contact being coupled to said peripheral wall of said case wherein said first contact is configured to be placed in electrical communication with the electronic device when the electronic device is positioned in said case,
a plurality of second contacts, each of said second contacts being coupled to said back wall of said case, each of said second contacts being positionally aligned with an associated one of said tabs in said receiver, and
a plurality of first conductors, each of said first conductors being positioned within said back wall of said case, each of said first conductors being electrically coupled between an associated one of said second contacts and said first contact wherein each of said second contacts is configured to be in electrical communication with the electronic device when the electronic device is positioned in said case.

5. The assembly according to claim 1, wherein each of said set of couplers comprises a disk having a first surface, a second surface and an outer surface extending therebetween, said second surface being configured to be coupled to the vehicle.

6. The assembly according to claim 5, further comprising a lock being coupled to said first surface, said lock engaging said tabs when said selected coupler is positioned in said receiver such that said selected coupler is removably coupled to said case.

7. The assembly according to claim 6, wherein:
said first electrical circuit comprises a plurality of second contacts; and
said second electrical circuit comprises a plurality of third contacts, each of said third contacts being coupled to said lock, each of said third contacts being electrically coupled to an associated one of said second contacts when said selected coupler is positioned in said receiver.

8. The assembly according to claim 7, further comprising a switch being coupled to said outer surface of said disk wherein said switch is configured to be manipulated, said switch being electrically coupled to each of said third contacts.

9. The assembly according to claim 8, further comprising a plurality of ports, each of said ports being coupled to said outer surface of said disk wherein each of said ports is configured to be electrically coupled to the extrinsic electronic device, each of said ports being electrically coupled to said third contacts wherein each of said ports is configured to be in electrical communication with the electronic device.

10. The assembly according to claim 6, wherein said set of couplers includes a first coupler and a second coupler, a selected one of said first coupler and said second coupler being removably coupled to said receiver, said lock corresponding to each of said first coupler and said second coupler comprising a wafer being coupled to said first surface, said wafer having a distal surface with respect to said first surface and an outermost edge, said outermost edge having a first side and a second side, said first side being substantially coextensive with said outer surface, said second side extending laterally across said first surface such that said wafer has a semicircular shape, said first side being inset with respect to said outer surface.

11. The assembly according to claim 10, wherein:
said receiver includes an upper set of tabs and a pair of horizontally oriented slots; and
said first side has a pair of wells extending inwardly toward a center of said wafer, said wells being spaced apart from each other, said wafer extending into said pair of horizontally oriented slots when said first coupler and said second coupler is inserted into said receiver, each of said first coupler and said second coupler being urged upwardly in said receiver having each of said upper set of tabs is positioned in an associated one of said wells such that said first coupler and said second coupler is removably coupled to said receiver, said second side of said wafer being centrally positioned in said pair of horizontally oriented slots when said first coupler and said second coupler is removably coupled to said receiver.

12. The assembly according to claim 10, further comprising a retainer being movably coupled to said first surface, said retainer comprising a first arm intersecting with a second arm, said second arm being centrally positioned on said first arm such that said retainer has a T-shape, said retainer having an exposed surface, said first arm having an upper edge, said upper edge being coextensive with said second side of said wafer.

13. The assembly according to claim 12, wherein:
said receiver includes a pair of vertically oriented slots; and
said retainer is positioned in a retracted position having said retainer being recessed in said first surface, said retainer being positioned in an extended position having said retainer extending outwardly from said first surface such that said exposed surface of said retainer is oriented on a plane being planar with said distal surface of said wafer, said first arm being coextensive with said horizontally oriented slots when said retainer is in said extended position, said second arm extending downwardly in one of said vertically oriented slots such that said retainer inhibits said first coupler and said second coupler from sliding downwardly in said receiver.

14. The assembly according to claim 12, further comprising an actuator being coupled to said first coupler and said second coupler wherein said actuator is configured to be manipulated, said actuator being in mechanical communication with said retainer, said actuator urging said retainer into an extended position when said first coupler and said second coupler is positioned in said receiver such that said first coupler and said second coupler is locked in said receiver, said actuator urging said retainer into a retracted position when said first coupler and said second coupler is positioned in said receiver such that said first coupler and said second coupler is removable from said receiver.

15. The assembly according to claim 5, wherein set of coupler includes a second coupler, said second coupler comprising:
a shaft being coupled to and extending away from said second surface, said shaft being centrally positioned in said second surface; and
a ridge extending outwardly from said second surface, said ridge extending substantially between said outer surface of said second coupler and said shaft.

16. The assembly according to claim 15, further comprising a second disk having a primary surface and a secondary surface, said secondary surface being configured to be coupled to the vehicle, said primary surface having a first well extending inwardly toward said secondary surface, said first well being centrally positioned on said primary surface, said secondary surface having a plurality of channels extending inwardly toward said secondary surface, each of said channels radiating outwardly from said first well, said first well insertably receiving said shaft, said shaft frictionally engaging said first well such that said second coupler is movably coupled to said second disk, said second coupler being rotated to align said ridge with a selected one of said channels such that said second coupler is retained at a selected angle of rotation about said shaft wherein said second disk is configured to position the electronic device in a landscape position and a portrait position.

17. The assembly according to claim 5, wherein:
said receiver includes a plurality of tabs, a plurality of slots and a plurality of second contacts;
said set of couplers includes a third coupler, said third coupler being selectively coupled to said receiver, said lock corresponding to said third coupler comprising a plurality of arms each radiating outwardly from a central hub, said central hub being coupled to said first surface corresponding to said third coupler having each of said arms being spaced from said first surface, each of said arms having an engaging surface; and
each of said arms extending into an associated one of said slots in said receiver, said third coupler being urged to rotate into a locked position having each of said arms being positioned behind an associated one of said tabs such that said third coupler is removably coupled to said receiver, said third coupler being urged to rotate in an unlocked position having each of said arms being aligned with said associated slot such that said third coupler is removable from said receiver, each of a plurality of third contacts corresponding to said third coupler being coupled to said engaging surface of an associated one of said arms such that said third contacts are electrically coupled to said second contacts when said third coupler is coupled to said receiver.

18. An electronic device mounting assembly being configured to mount an electronic device to a vehicle, said assembly comprising:
a case being configured to contain an electronic device, said case having a back wall and a peripheral wall;
a receiver being coupled to said case, said receiver having an outer wall being coupled to and extending away from said back wall of said case, said outer wall being continuous such that said outer wall defines a circle, said outer wall having an inner surface and a distal edge with respect to said back wall, said receiver having a plurality of tabs, each of said tabs being coupled to said inner surface, each of said tabs having a pair of lateral edges and a distal edge with respect to said outer wall, each of said lateral edges corresponding to each of said tabs angling inwardly between said outer wall and said distal edge of said corresponding tab such that each of said tabs has a trapezoidal shape, said tabs being spaced apart from each other and being distributed around said outer wall to define a plurality of slots between said lateral edges corresponding to each of said tabs, each of said tabs being aligned with said distal edge corresponding to said outer wall such that each of said tabs is spaced from said back wall of said case, said plurality of tabs including an upper set of tabs and a lower set of tabs, said slots including a pair of horizontally oriented slots and a pair of vertically oriented slots;
a first electrical circuit being coupled to said case, said first electrical circuit being configured to be in electrical communication with the electronic device when the electronic device is positioned in said case, said first electrical circuit comprising:
a first contact being coupled to said peripheral wall of said case wherein said first contact is configured to be placed in electrical communication with the electronic device when the electronic device is positioned in said case,
a plurality of second contacts, each of said second contacts being coupled to said back wall of said case, each of said second contacts being positionally aligned with an associated one of said tabs in said receiver, and
a plurality of first conductors, each of said first conductors being positioned within said back wall of said case, each of said first conductors being electrically coupled between an associated one of said second contacts and said first contact wherein each of said second contacts is configured to be in electrical communication with the electronic device when the electronic device is positioned in said case; and
a set of couplers, each of said couplers being configured to be selectively coupled to a vehicle, a selected one of said couplers engaging said receiver such that said selected coupler is removably coupled to said case wherein said selected coupler is configured to couple the electronic device to the vehicle, each of said couplers having a second electrical circuit being coupled thereto, said second electrical circuit being in electrical communication with said first electrical circuit when said selected coupler is coupled to said receiver wherein said selected coupler is configured to be in electrical communication with the electronic device when the electronic device is positioned in said case, said second electrical circuit being configured to be placed in electrical communication with an extrinsic electronic device thereby facilitating the electronic device to communicate with the extrinsic electronic device, each of said set of couplers comprising:
a disk having a first surface, a second surface and an outer surface extending therebetween, said second surface being configured to be coupled to the vehicle,
a lock being coupled to said first surface, said lock engaging said tabs when said selected coupler is positioned in said receiver such that said selected coupler is removably coupled to said case,
said second electrical circuit comprising:
a plurality of third contacts, each of said third contacts being coupled to said lock, each of said third contacts being electrically coupled to an associated one of said second contacts when said selected coupler is positioned in said receiver,
a switch being coupled to said outer surface of said disk wherein said switch is configured to be manipulated, said switch being electrically coupled to each of said third contacts, and
a plurality of ports, each of said ports being coupled to said outer surface of said disk wherein each of said ports is configured to be electrically coupled to the extrinsic electronic device, each of said ports being electrically coupled to said third contacts wherein each of said ports is configured to be in electrical communication with the electronic device,
said set of couplers including a first coupler and a second coupler, a selected one of said first coupler and said second coupler being removably coupled to said receiver, said lock corresponding to each of said first coupler and said second coupler comprising:
a wafer being coupled to said first surface, said wafer having a distal surface with respect to said first surface and an outermost edge, said outermost edge having a first side and a second side, said first side being substantially coextensive with said outer surface, said second side extending laterally across said first surface such that said wafer has a semicircular shape, said first side being inset with respect to said outer surface, said first side having a pair of wells extending inwardly toward a center of said wafer, said wells being spaced apart from each other, said wafer extending into said pair of horizontally oriented slots when said first coupler and said second coupler is inserted into said receiver, each of said first coupler and said second coupler being urged upwardly in said receiver such that each of said upper set of tabs is positioned in an associated one of said wells such that said first coupler and said second coupler is removably coupled to said receiver, said second side of said wafer being centrally positioned in said pair of horizontally oriented slots when said first coupler and said second coupler is removably coupled to said receiver, each of said third contacts corresponding to said first coupler and said second coupler being positioned on said distal surface of said wafer such that each of said third contacts corresponding to said first coupler is electrically coupled to said second contacts when said first coupler and said second coupler is coupled to said receiver,
a retainer being movably coupled to said first surface, said retainer comprising a first arm intersecting with a second arm, said second arm being centrally positioned on said first arm such that said retainer has a T-shape, said retainer having an exposed surface, said first arm having an upper edge, said upper edge being coextensive with said second side of said wafer, said retainer being positioned in a retracted position having said retainer being recessed in said first surface, said retainer being positioned in an extended position having said retainer extending outwardly from said first surface such that said exposed surface of said retainer is oriented on a plane being planar with said distal surface of said wafer, said first arm being coextensive with said horizontally oriented slots when said retainer is in said extended position, said second arm extending downwardly in one of said vertically oriented slots such that said retainer inhibits said first coupler and said second coupler from sliding downwardly in said receiver, and
an actuator being coupled to said first coupler and said second coupler wherein said actuator is configured to be manipulated, said actuator being in mechanical communication with said retainer, said actuator urging said retainer into said extended position when said first coupler and said second coupler is positioned in said receiver such that said first coupler and said second coupler is locked in said receiver, said actuator urging said retainer into said retracted position when said first coupler and said second coupler is positioned in said receiver such that said first coupler and said second coupler is removable from said receiver;
said second coupler comprising:
a shaft being coupled to and extending away from said second surface, said shaft being centrally positioned in said second surface, and
a ridge extending outwardly from said second surface, said ridge extending substantially between said outer surface of said second coupler and said shaft,
a second disk having a primary surface and a secondary surface, said secondary surface being configured to be coupled to the vehicle, said primary surface having a first well extending inwardly toward said secondary surface, said first well being centrally positioned on said primary surface, said secondary surface having a plurality of channels extending inwardly toward said secondary surface, each of said channels radiating outwardly from said first well, said first well insertably receiving said shaft, said shaft frictionally engaging said first well such that said second coupler is movably coupled to said second disk, said second coupler being rotated to align said ridge with a selected one of said channels such that said second coupler is retained at a selected angle of rotation about said shaft wherein said second disk is configured to position the electronic device in a landscape position and a portrait position;
said set of couplers including a third coupler, said third coupler being selectively coupled to said receiver, said lock corresponding to said third coupler comprising a plurality of arms each radiating outwardly from a central hub, said central hub being coupled to said first surface corresponding to said third coupler having each of said arms being spaced from said first surface, each of said arms having an engaging surface, each of said arms extending into an associated one of said slots in said receiver, said third coupler being urged to rotate into a locked position having each of said arms being positioned behind an associated one of said tabs such that said third coupler is removably coupled to said receiver, said third coupler being urged to rotate in an unlocked position having each of said arms being aligned with said associated slot such that said third coupler is removable from said receiver, each of said third contacts corresponding to said third coupler being coupled to said engaging surface of an associated one of said arms such that said third contacts are electrically coupled to said second contacts when said third coupler is coupled to said receiver.
